(19) United States
(12) Patent Application Publication
(10) Pub. No.: US 2007/0230910 A1
(43) Pub. Date: Oct. 4, 2007

(54) Apparatus and Method for Two-Way Remote Control and Cradle or Adaptor to Control an A/V Media Player

(75) Inventors: Eric Welch, Berkeley, CA (US); Lucy McCoy, Berkeley, CA (US); Jeremy Bramson, Oakland, CA (US); Sam Freeman, Albany, CA (US)

Correspondence Address: REED SMITH, LLP, TWO EMBARCADERO CENTER, SUITE 2000, SAN FRANCISCO, CA, 94111, US

(73) Assignee: InnoSys Incorporated, Richmond, CA (US)

(21) Appl. No.: 11/682,260

(22) Filed: Mar. 5, 2007

Related U.S. Application Data
(60) Provisional application No. 60/778,643, filed on Mar. 4, 2006.

(51) Int. Cl. H04N 7/00

(52) U.S. Cl. 386/96

(57) ABSTRACT

A hand-help Remote Control and an associated Cradle or Host Adapter communicate to send and receive data. The Remote is battery powered, has an LCD screen and buttons and is intended for thumb operation in either hand. The Cradle unit is attached to a portable Music Player (or video player) such as the Apple iPod® and communicates with the Remote. The Host Adapter connects to a computer running a Music Player Software Application and communicates with the Remote. The Cradle or Host Adapter communicate wirelessly with the Remote and enable the user to control a Music Player, display and navigate through the Music Player database, select a particular item to play on the player and/or change sound properties such as volume output of the Cradle unit. The LCD also displays the status of the player such as song or video currently playing, position into the selection, volume level and other items.

This application claims the benefit of U.S. Provisional Application No. 60/778,643, filed Mar. 4, 2006, the disclosure of which is herein incorporated by reference.

### BACKGROUND OF THE INVENTION

1. Field of the Invention

The present invention relates generally to remote control devices, and more particularly to a remote control for controlling a portable music player, video player, and the like.

2. Description of the Related Art

Music players, MP3 players, Apple iPods, and other portable music and/or video players are increasingly being promoted and used in two distinctly different ways. The original and primary use was as a portable battery-powered music player. The additional use that has grown as a secondary function is that of combining the portable player with some other home audio or home theatre function. In some cases, particular users may consider this to be the primary and not a secondary use.

Thus, it is desirable to adapt these audio and/or video portable electronic devices for convenient home use.

### SUMMARY OF THE INVENTION

In general, there is a need to provide remote control of portable entertainment devices, particularly iPod® type devices coupled with audio, theater, and the like. Accordingly, in one embodiment, the present invention includes a remote control configured to allow a user to control an iPod® or other entertainment device as if the entertainment device was in the user's hand. When used in this manner, the entertainment portable device is generally placed into some type of Dock or other fixed unit which often has, for example, the combined function of creating a wired or wireless connection to the rest of the audio system so that the portable player can be another “audio source”, provide power for charging the portable device's batteries and sometimes, providing data communication with a personal computer (PC) for the purpose of downloading music or video or other information, and/or synchronizing information between the player and the PC.

The remote control may be configured so that the user can operate the player at a distance and allow the user to see and navigate an entertainment database (e.g. music database or play list) by just using the remote. For example, the remote may be configured with a LCD screen and two-way communication between the Remote and Cradle and allowing the user to see and read the status of the player, navigate the music/video database, etc. In one embodiment, the remote control is also configured to perform management functions, such as add, edit and delete music and video files stored in the entertainment database.

Hereinafter, the term “Music Player” refers to any portable MP3, iPod™ or other music player, video player or similar audio/visual electronic device with which a specific version of the Cradle of the present invention has been designed to work. The present invention is not limited to music players, but is described herein as a music player for convenience and not by way of limitation.

The remote may comprise a wireless RF Remote Control with buttons and an LCD screen in communication with one of a Standalone Cradle, a Cradle Adapter, or a Host Adapter that is connected to either a portable Music Player or, in the case of the Host Adapter, a Music Player Application. The Remote is used, for example, to control the Music Player or to navigate its music database using its buttons and LCD screen.

The Cradle has a microprocessor, elements for communicating with the Music Player (commonly serial or USB), some type of power management and a two-way digital radio. The radio operates, for example, in one of the unlicensed ISM bands (e.g. 2.4 GHz) using a Digital Spread Spectrum or Frequency Hopping technique. The Cradle has various forms. For Example, in one embodiment, the Cradle is a complete standalone unit into which the Music Player is plugged. In addition to the processing and radio components, the Cradle has connections for USB/Power, audio, video.

In another embodiment, the Cradle Adapter form, the Cradle functions as a physical intermediary between the Music Player and a 3^{rd} party Music Player Dock. In this way, the two-way Remote Control functions can be an “after market” accessory to an existing 3^{rd} party Dock, for example an integrated home entertainment system with speakers, video and other components. The Cradle Adapter looks to the 3^{rd} party Dock just like the Music Player and the Cradle Adapter emulates the Music Player's digital control interface so that commands like play/pause, volume up/down, etc are accepted and processed in the Cradle Adapter.

The Cradle's processor contains Flash Memory for storing the operating firmware for the unit as well as fonts and graphics used on the Remote. The RAM in the processor is used for storing data necessary for the operation of the Cradle firmware as well as to keep track of the state of the Remote. RAM in the Cradle processor is also used to cache music/video database information from the Music Player device.

The Host Adapter is a USB Device comprising a Microprocessor with RAM and USB Interface. It also contains the same Digital Radio as the Cradle. The Host Adapter contains minimum electronics to perform it basic functionality. For example, in one embodiment, it doesn't contain audio circuitry. The Host Adapter's Digital Radio communicates with the Remote and, for example, in conjunction with application software, also manages applications such as iTunes® running on a Mac® or PC. The Remote provides the ability, via the Host Adapter, to see music and/or other entertainment files available to the managed applications when a user is not physically at the computer.

The Remote has batteries, an LCD screen, a microprocessor, a digital radio identical to that in the Cradle, and buttons. It is specifically designed for operation in one hand (left or right) with the thumb.

The Remote, in one instance, operates with very tight coupling to the Cradle or Host Adapter and every button press on the Remote results in a short radio message to the Cradle or Host Adapter. The Cradle or Host Adapter responds to this with data that is used to update the LCD.

In another instance the basic menu handling state machine and some local data is kept on the Remote. In this case, each keystroke will cause the LCD screen to change without sending radio messages as long as this “navigation” stays within the limited amount of menu data stored in the Remote. When the user navigates outside this limited amount of data, radio messages are exchanged with the Cradle or Host Adapter to fetch more data.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram showing an embodiment of interconnection of the major components in a standalone Cradle case: 1) the Music Player, 2) the Cradle, 3) the external Audio System and 4) the Remote Control;

FIG. 2 is a block diagram showing an embodiment of interconnection of the major components in the Cradle Adapter case: 1) the Music Player, 2) the Cradle Adapter, 3) the 3^{rd} party Dock, 4) the Remote Control;

FIG. 3 is a block diagram showing the embodiment of interconnection of the major components in the Host Adapter case: 1) Host USB PC, 2) Host Adapter, 3) the Remote Control;

FIG. 4 is a block diagram of the Remote Control showing an embodiment of microprocessor, LCD screen, Digital Radio, RF Power Amplifier, Antenna, and keypad;

FIG. 5 is a block diagram of the Cradle showing an embodiment of microprocessor, iPod connector, audio sub-section, Digital Radio, RF Power Amplifier, Antenna, external USB, Audio and S-Video connectors;

FIG. 6 is a block diagram of an embodiment of the Cradle Adapter showing microprocessor, iPod connector, Dock connector, Digital Radio, RF Power Amplifier, Antenna, and audio sub-section;

FIG. 7 is a block diagram of embodiment of the Host Adapter showing a microprocessor, USB connector for the Host, Digital Radio, RF Power Amplifier and Antenna;

FIG. 8 is a drawing of a remote according to an embodiment of the present invention;

FIG. 9 is a logic flow chart showing details of the processing algorithm and internal states of the system, according to an embodiment of the present invention;

FIG. 10 is a logic flow for keypad events, according to an embodiment of the present invention;

FIG. 11 is a logic flow for Song Display Mode, according to an embodiment of the present invention;

FIG. 12 is a drawing of a remote that illustrates a Main Menu according to an embodiment of the present invention; and

FIG. 13 is a drawing of a remote that illustrates a Song Display according to an embodiment of the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

As noted above, the term “Music Player” refers to any portable MP3, iPod™ or other music player, video player or similar audio/visual electronic device with which a specific version of the Cradle of the present invention has been designed to work. The present invention is not limited to music players, but is described herein as a music player for convenience and not by way of limitation.

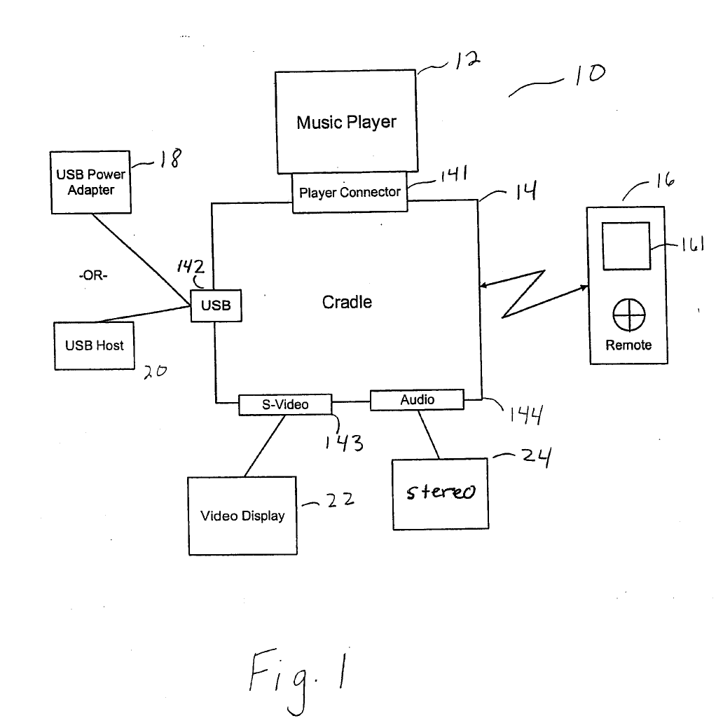

Connections of System and External Devices (FIGS. 1-3)

This section concerns the inter-connection of the system 10 (Remote 16, Cradle 14 and Cradle Adapter 28) and external devices including the Music Player 12, and audio and video components like television sets, video cassette recorders, digital video recorders, audio amplifiers or receivers, speakers, etc.

As illustrated in FIG. 1, the Standalone Cradle 14 supports the Music Player 12 in several activities. The Cradle 14 allows the Music Player 12 to charge its battery; it will support a USB connection 142 to a Music Database host for synchronization of information and downloading of music and video. The USB port 142 may connect to either a USB Host 20 or a USB Power Adaptor 18. The Music Player 12 connects to the Cradle 14 via a player connector 141. The Cradle 14 also provides appropriate connections for external audio 144 and video 143 devices so that the Music Player 12 can play music and video to external audio 24 and video 22 components.

The Standalone Cradle 14 also communicates with the two-way Remote 16 to allow control, navigation and display of status on the Remote's LCD screen 161.

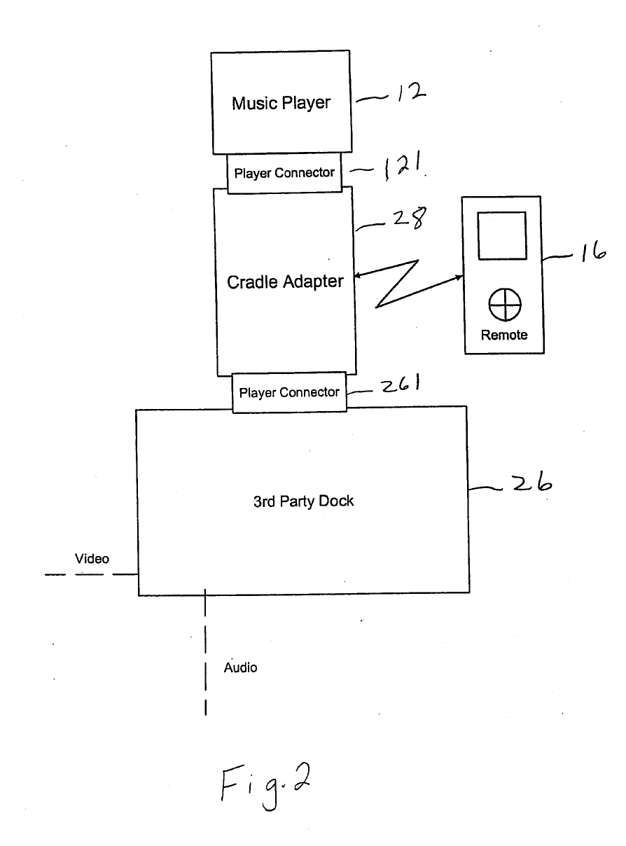

As shown in FIG. 2., the Cradle Adapter 28 is similar except that it doesn't contain USB, audio or video connectors. Instead it is designed to physically intercede between the Music Player 12 and an existing 3^{rd} party Dock 26, via player connectors 121 and 261. To the 3^{rd} party Dock 26, the Cradle Adapter 28 looks physically, electrically and logically like the Music Player 12 itself. To the Music Player 12 it looks like a Cradle or Dock.

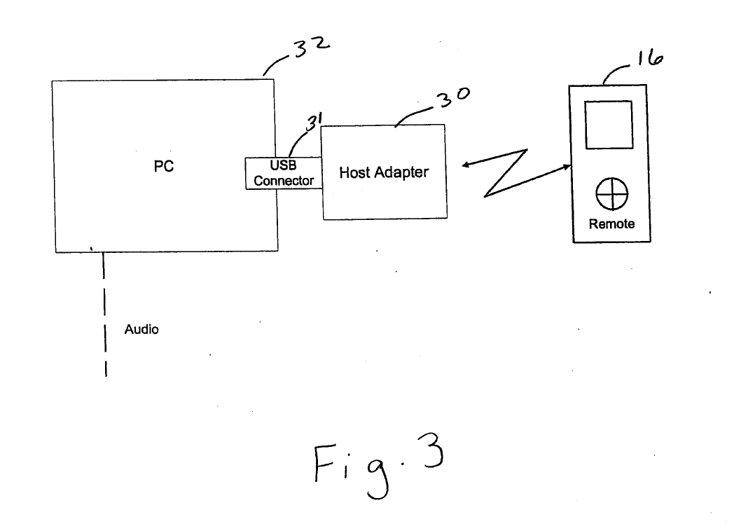

A Host Adapter 30, FIG. 3, allows the Remote 16 to control music player software running on a personal computer (PC) 32. The Host Adapter 30 provides Digital Radio communication with the Remote 16 but has no corresponding hardware for audio or video as in the Standalone Cradle 14 or Cradle Adapter 28.

Device Pairing and Frequency-Hopping

In order to operate devices with two-way radios in the 2.4 HGz or other ISM band, some type of spread spectrum scheme is used to avoid different products interfering with one another. In one instance, the Remote 16 and Cradle 14, Cradle Adaptor 28, or Host Adapter 30 use frequency hopping over approximately 80 channels to meet this requirement. In addition, this allows multiple pairs of Cradles or Host Adapters and Remotes to interoperate in the same area. When the frequency-hopping scheme detects a channel with interference, another is selected automatically without the end-user being aware.

At any one time, a given Cradle, Cradle Adapter or Host Adapter only communicates with one Remote at a time. Before any given Cradle, Cradle Adapter or Host Adapter will allow communication with a given Remote, the devices must be paired. The Remotes are manufactured with unique serial numbers. In order to pair, the end-user presses the “pairing” button on the bottom of the Cradle and presses any button on the Remote. This causes the Cradle to record that Remote's serial number in flash memory and will keep up to four serial numbers in this manner. From then on, multiple Remotes (e.g., 1 to 4 Remotes, but only one at a time) may be used with the given Cradle. With the Host Adapter, the pairing function may utilize a user interface application on the PC.

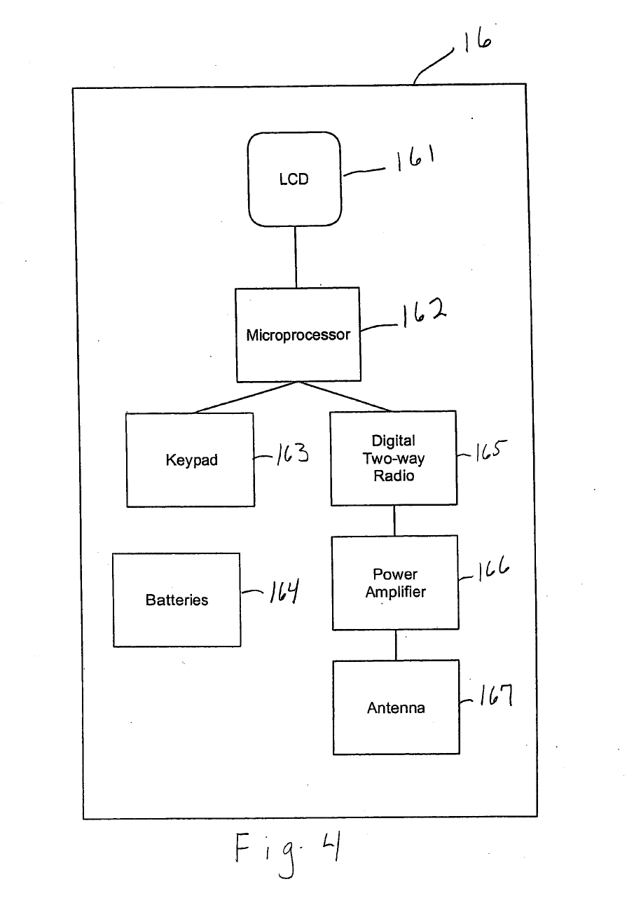

Remote Components and Operation (FIG. 4)

The following is one instance of the Remote 16; as with all the descriptions provided herein, other implementations are envisioned and numerous variations and/or modifications may be made after review of the present disclosure which do not depart from the spirit and scope of the present invention.

The two-way Remote 16 is a hand-held battery powered device shaped roughly like a common universal entertainment remote. However the two-way Remote 16 has a 1.5″ LCD screen and a multiple button keypad 163. In one instantiation, the LCD screen 161 is a color CSTN device with 128×128 pixels. The Keypad 163 has 10 buttons and the batteries 164 are two AA alkaline. Inside, the Remote 16 is operated by a very low power microprocessor 162 that is connected to the LCD screen 161, the Digital Radio 165, the keypad 163 and to an external USB connector (not shown). The USB connection is used support field updating or operating firmware and/or fonts.

The Remote also contains a Digital Radio 165. In various embodiments, the Digital Radio 165 is capable of operating at either 250 Kbits/sec or 1 Mbits/sec, and a 10 dB RF Power Amplifier 166. The Digital Radio 165 has longer range at the 250 Kb rate and at this rate and with the RF Power Amplifier 166, a range of 30 meters or more indoors and through walls is possible. The Remote 16 also includes an antenna 167.

To conserve battery power, the Remote 16 is mostly asleep, although it does not need to have an on-off switch. Any button press and certain timer conditions will cause the Remote 16 to wake up. Its basic operation is that it is awakened by a button press, it sends that button code to the Cradle 14, 28 or Host Adapter 30 in a radio message, the Cradle 14, 28 or Host Adapter 30 responds with coded and compressed instructions and data for updating the LCD screen 161. The Remote 16 carries out those instructions and puts the processor back to sleep.

When awakened, the LCD screen 161 is turned on and updated with instructions from the Cradle 14, 28 or Host Adapter 30. Whenever the LCD screen 161 is updated the Remote 16 leaves it on for a fixed amount time (say, 30 seconds) before putting it to sleep.

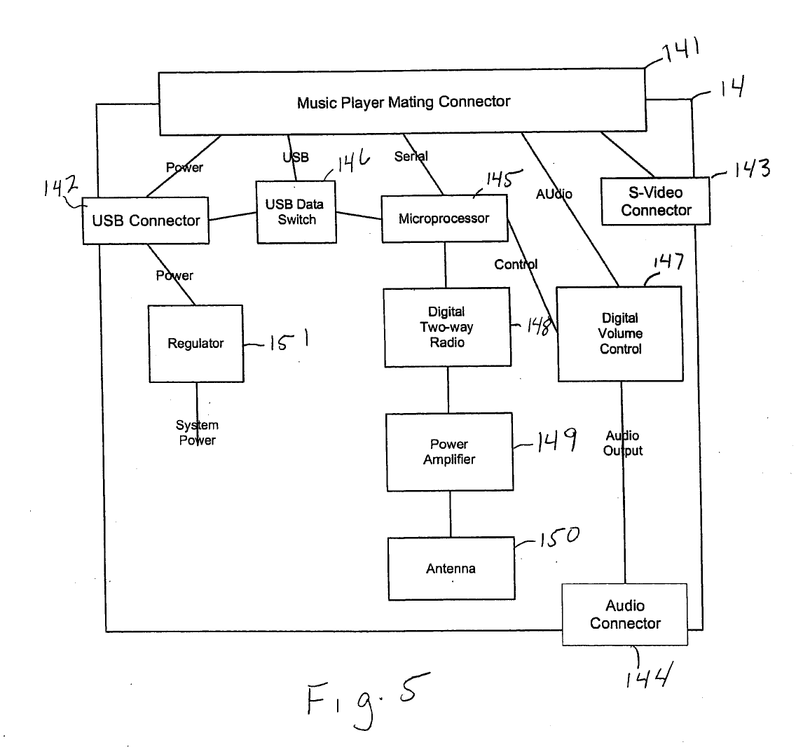

Standalone Cradle Components and Operation (FIG. 5)

The following is one instance of the Standalone Cradle 14; again, other implementations are envisioned by these descriptions.

The illustrated standalone Cradle 14 has four external connectors: USB 142, Music Player Mating Connector 141, S-Video 143 and Audio 144. It includes a Microprocessor 145, a USB Data Switch 146, a Digital Volume Control device 147, a Digital Radio 148, an RF Power Amplifier 149 and Antenna 150. The Microprocessor 145 communicates with the Music Player 12 via USB or Serial, controls the USB Data Switch 146, the Digital Radio 148 and the Digital Volume Control device 147.

The Music Player 12 is attached to the Music Player Mating Connector 141 and the Standalone Cradle 14 is physically arranged so that the Music Player 12 is supported in an upright position.

The USB Connector 142 is use to attach the Standalone Cradle 14, via a standard USB Cable to either a USB Host 20 or a USB Power Adapter 18. Both cases provide power for charging the Music Player 12 and powering the Cradle 14 electronics. The data signals of the USB connector 142 are routed to a USB Data Switch 146 and can be switched under control of the Microprocessor 145(e.g. an Arm 7 microprocessor) to either the Music Player 12 or the Microprocessor 145. When connected to the Music Player 12 it allows the Music Player's 12 built in functions for communicating with a USB Host 20 for data synchronization or download. When connected to the Cradle's Microprocessor 145 it supports firmware update, font update or other related functions (e.g. run applications, play tracks stored internally in the Cradle, etc.). In one embodiment, the data signals from the Music Player 12 are routed through the Microprocessor 145 for audio and/or video processing.

Audio is controlled in the Standalone Cradle 14 by a circuit that connects the Music Player's 12 audio output via a Digital Volume Control Device 147 to the external audio connector 144. The Microprocessor 145 controls the volume level by sending serial digital signals to the Digital Volume Control Device 147. The Digital Volume Control Device 147 is biased such that its maximum level corresponds to 0 dB of attenuation and at its lowest level the audio output is effectively muted.

The Standalone Cradle 14 contains a Digital Radio 148, an RF Power Amplifier 149 and an Antenna 150 complementary and in communication with the Remote 16. The Digital Radio 148 is a half-duplex device and can only either transmit or receive. In one embodiment, a radio message protocol between the Remote 16 and Cradle 14 utilizes the Remote 16 to initiate communication and transmit first. Accordingly the Digital Radio 148 in the Cradle 14 is normally left on in Receive mode.

The Cradle 14 also may include a Regulator 151 to control the power from the USB connector 142 for powering the system.

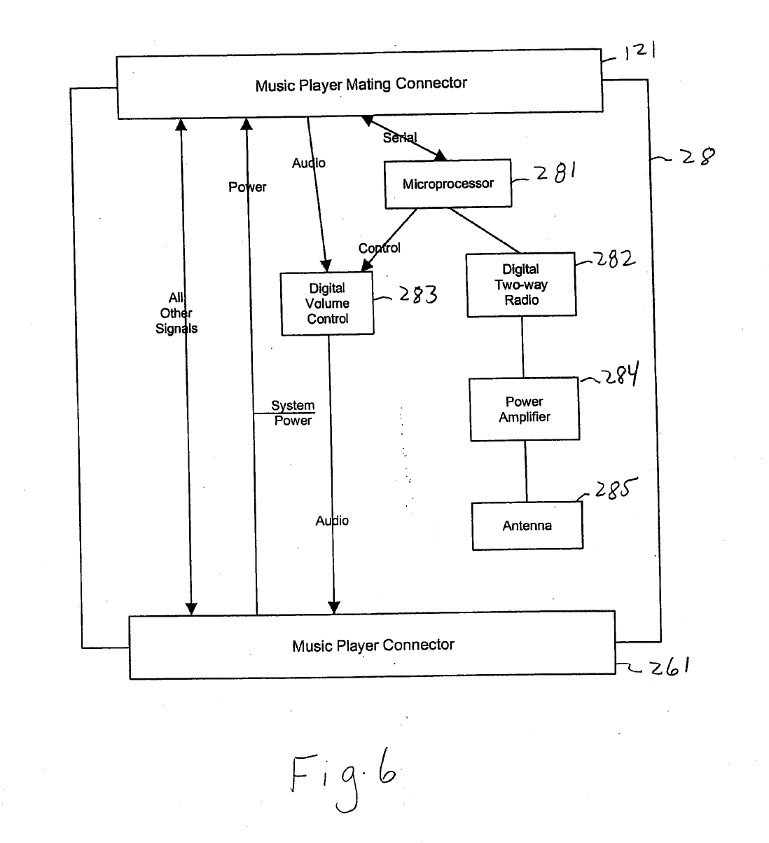

Cradle Adapter Components and Operation (FIG. 6)

The following is one instance of the Cradle Adapter 28; again other implementations are envisioned by these descriptions.

Although some embodiments may incorporate the same features or connections as the Standalone Cradle 14, in one embodiment the Cradle Adapter 28 is similar to the Standalone Cradle 14 except that it has no USB, Audio or Video connectors. The Cradle Adapter 28 has one Music Player Mating Connector 121 used to attach the Music Player 12 as with the Standalone Cradle 14. The Cradle Adapter 28 also has a second Music Player Connector 261 for attachment to a 3^{rd} party Dock's Music Player Mating Connector (not shown).

The Cradle Adapter 28 implements volume control in the same manner as the Standalone Cradle 14, via a Digital Volume Control 283, except that the audio output is connected to the second Music Player Connector 261.

Power can be provided to the Cradle Adapter 28 in several ways including via the 3^{rd} party Dock and the Music Player. Other signals are routed between the Music Player Mating Connector 121 and the second Music Player Connector 261 unchanged.

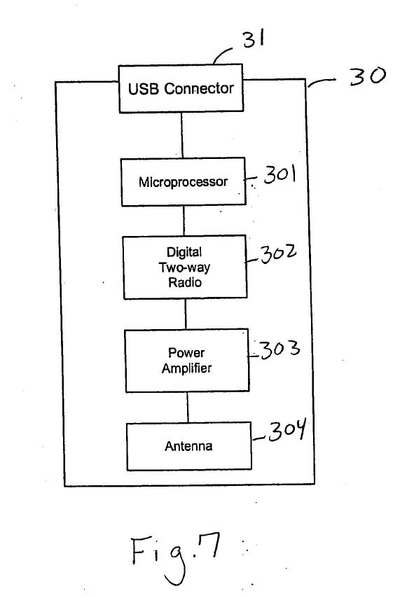

Host Adapter Components and Operation (FIG. 7)

The following is one instance of the Host Adapter 30; again, other implementations are envisioned by these descriptions.

The Host Adapter 30 is a USB Dongle that contains a Microprocessor 301 that includes USB interface logic. The Host Adapter 30 also contains a similar Digital Radio 302, and an RF Power Amplifier 303 as in the two Cradles. The Antenna 304, in this embodiment, may be, for example, a PCB Trace Antenna. Preferably, the Host Adapter 30 only contains enough logic and electronics to perform Host Adapter functions. For example, the Host Adapter 30 does not include audio circuitry.

The Host Adapter 30 allows the two-way Remote 16 to control not a physical Music Player 12, but a Music Player Software Application such as Apple's iTunes™ on a Windows or Macintosh Personal Computer. The Host Adapter 30 firmware operates only the Digital Radio 302. Other software is deployed to control the Music Player Application and runs on the PC 32 itself, in communication with the USB Host Adapter Digital Radio sub-system.

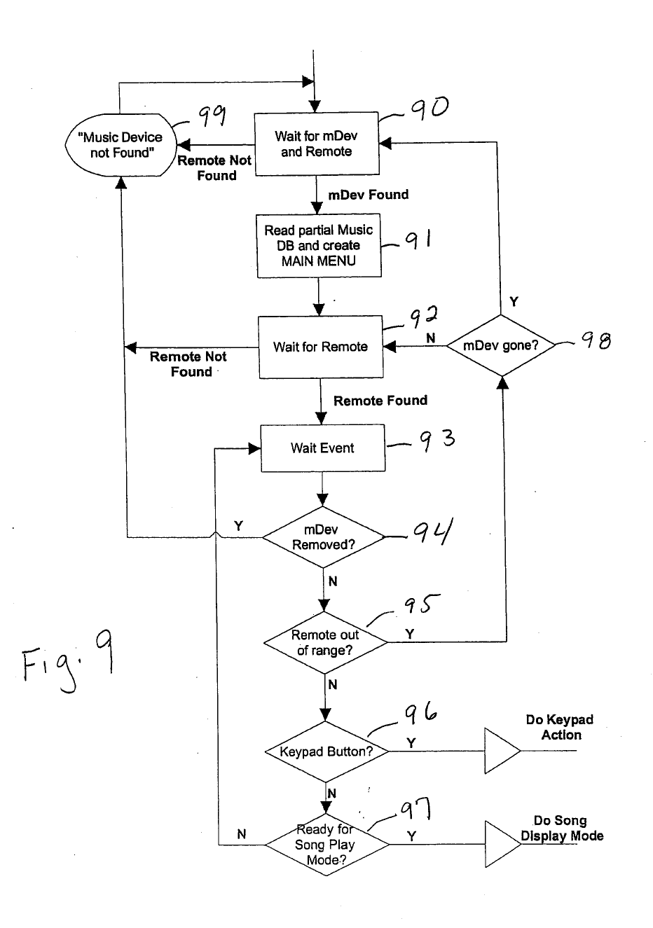

Standalone Cradle Main Processing Logic (FIG. 9)

The operation of the Cradle will now be described with reference to FIG. 9. The Cradle 14 initializes itself by setting up its internal data structures, and waiting to detect the Music Player 12 (step 90) and Remote's 16 radio message (step 92). When no Music Player 12 is detected, the Cradle 14 loops in a detection state (step 99).

The Cradle 14 initializes the Digital Radio 148 by turning on the receiver and waiting to be contacted by the Remote 16. For power management reasons, radio communication is initiated by the Remote 16. The connection is half duplex and after sending its message the Remote 16 turns off its transmitter and turns on its receiver. The Cradle 14 is always expected to send some response even if it doesn't have any data and the exchange ends when the Cradle 14 indicates that it is done.

When a Music Player 12 is detected, the Cradle 14 reads the top-level hierarchical music database information and populates its cache with enough information to display initial information on the Remote 16 (step 91).

After this, and after a Remote 16 has been detected (the Cradle communicates with one Remote at a time) the Cradle 14 will cause the Main Menu to be displayed on the Remote 16 (step 91). The Main Menu is created from scratch by the Cradle 14 and doesn't relate to data from the Music Player 12.

After this the Cradle 14 goes into its main event loop (step 93). In this state, the Cradle 14 waits on the following events:
1. The Music Player is removed (step 94)
2. The Music Player indicates that its player state has changed
3. The Remote sends a message (step 96)
   If the Music Player is removed (step 94), the Cradle 14 waits for it to be returned and displays a “Music Player Removed” icon on the Remote 16.

If the Music Player 12 is playing, the Cradle 14 waits for a certain delay and if no key has been pressed (step 96) on the Remote 16 in that time, goes into “Song Display Mode” (step 97). If a key is pressed, the keyboard action is performed.

The top level processing logic for the Cradle Adapter 28 is similar to that of the Standalone Dock except that, since the Cradle Adapter 28 is powered by the Music Player 12, the state of being in communication with the Remote 16, and where the Music Player 12 is detached, doesn't exist.

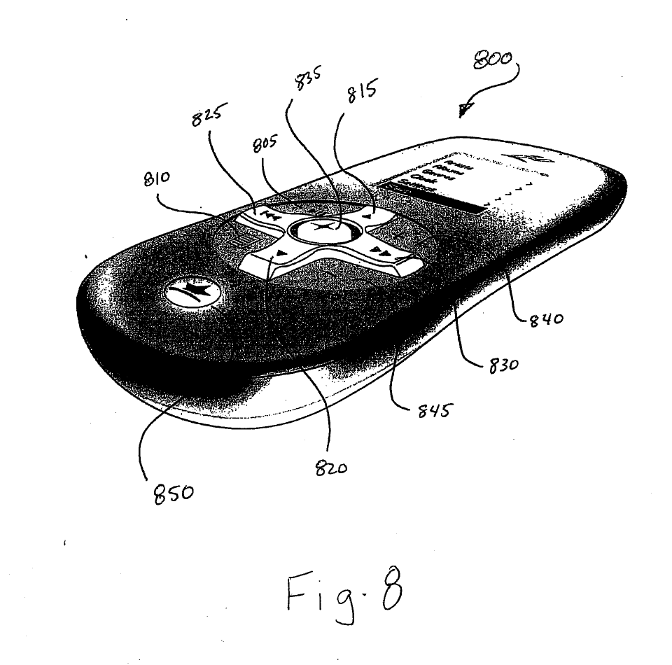

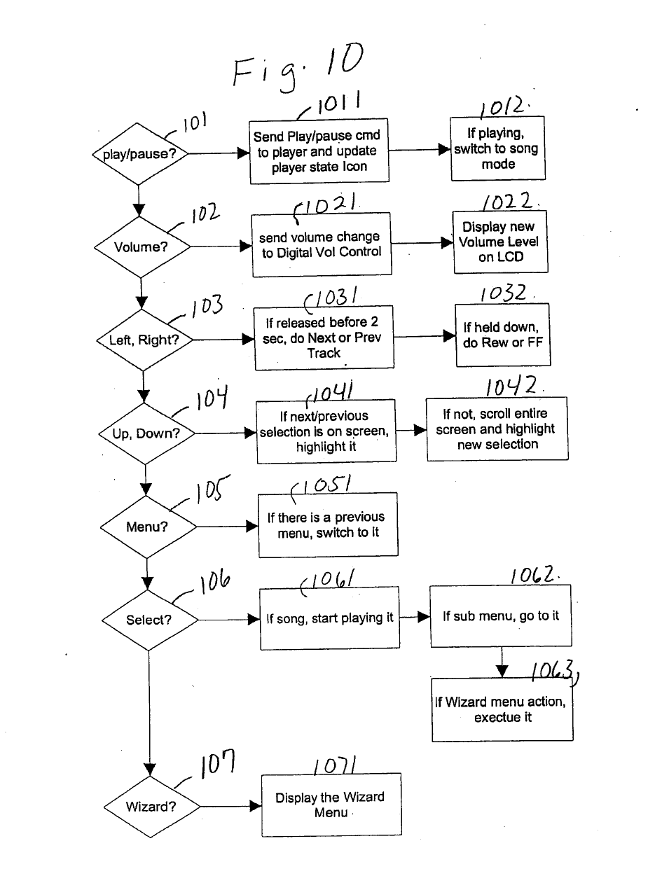

Keypad Logic—both Cradles and Host Adapter (FIGS. 8 and 10)

One embodiment of a Remote 800 illustrated in FIG. 8 has the following ten keys:
Play/Pause, 805;
Menu, 810;
Up, 815;
Down, 820;
Left, 825;
Right, 830;
Select, 835;
Volume UP, 840;
Volume Down, 845; and
Wizard, 850.

The following provides an example set of functionality associated with specific keys of the remote and how invocation of those keys interact with the Cradle 14. Although a preferred arrangement is described, other allocations of the same, additional or less functionality on these or other keys may be implemented.

Play/Pause

As shown in FIG. 10, if the Play/Pause button is pressed (step 101), the corresponding play/pause command is sent to the Music Player Device or Application as appropriate (step 1011). The Remote will temporarily show “Player Starting” and the name of the selection. If the Player reports that its status has changed to “Playing” the Remote is switched to “Song Display Mode” (step 1012).

Volume Up and Volume Down

If Volume Up or Volume Down is selected (step 102), the Cradle 14 sends the corresponding command to the Digital Volume Control device (step 1021). If the level is at maximum when the Volume Up is pressed, no change in volume is made. Similarly, if the level is at minimum when the Volume Down is pressed, no change in volume is made.

In addition to possibly changing the volume level in the Cradle, the Remote's LCD display is changed temporarily, in one embodiment, to show, in the low ⅓, a visual representation of the current volume (step 1022). This takes the form of a row of up to 16 icons arranged left to right each one a single pixel higher than the one to the left. The number of icons (0-16) will correspond to the volume level. This display remains active and is updated if another Volume Up or Down button is pressed. If any other key is pressed or if 3 seconds elapses with no key pressed, the display reverts to what it was previously.

Left and Right Left and Right do nothing if the Player is not playing. If the Player is playing, and the Left or Right if pressed (step 103) and released within a preset time period (e.g., 3 seconds) then the actions Previous Track or Next Track are taken, respectively (step 1031). If the Left or Right key is pressed and held down for a predetermined time period (e.g., 3 seconds) then the function Rewind or Fast Forward are started and continued for as long as the key is held down (step 1032).

While Rewind or Fast Forward is taking place, appropriate corresponding icons are displayed in the upper left (either in Menu or Song Display Mode).

Up and Down

In Menu mode Up and Down (step 1 04)cause the previous or next choice to be highlighted, respectively (step 1041). If the next appropriate selection is already visible, the display is not scrolled. If the next appropriate selection is either above the item currently displayed at the top of the menu or is below the one currently at the bottom, the display is scrolled by one (step 1042). If held down these keys cause continuous scrolling to take place. While being held down, scrolling accelerates in a long menu.

Up and Down and scrolling is controlled entirely in the Cradle (or Application on the USB Host as appropriate). In the Cradle (both Standalone and Adapter) music database information is cached from the Music Player. Due to RAM limitations, not all of the music database can be stored in the Cradle at a time. In fact, even a single menu may contain more items than can be stored at one time. Because of this, the menu handling state machine in the Cradle keeps local data structures that track the current display and as the user scrolls up or down, may have to discard items on the other end of the current menu to make room for items to make the next required display. Additional RAM may be provided to increase menu storage capacity.

Menu

If the current display is the Main Menu, the Menu key (step 105) does nothing. Otherwise, the Menu key causes the current display to be replaced with the menu display next higher in the hierarchy, restoring the menu exactly as it was before the selection was made that caused a move deeper into the hierarchy (step 1051).

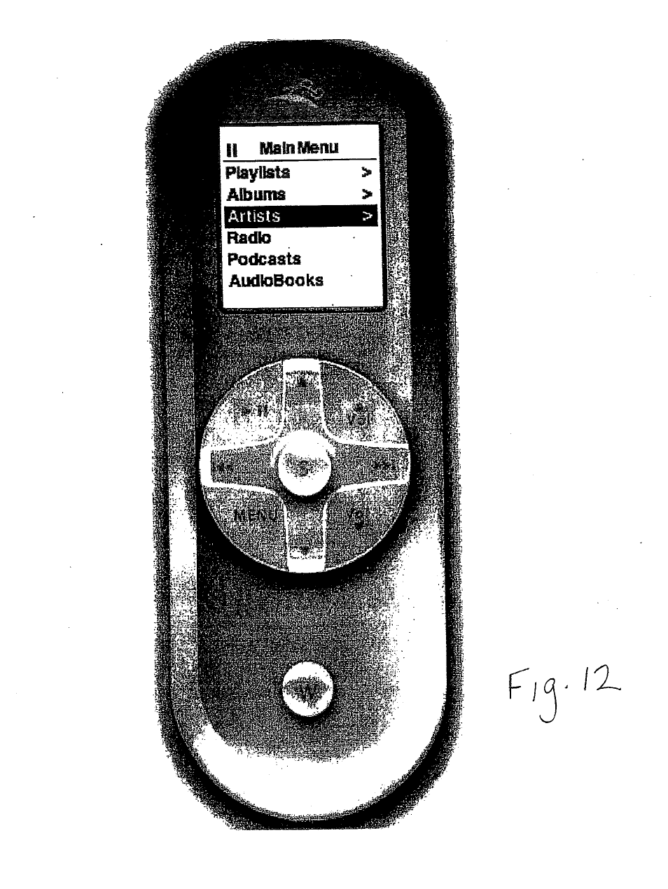

As example of a Main Menu displayed is illustrated in FIG. 12.

Select

Whenever a menu is displayed, one item on the visible menu is highlighted in reverse-video to indicate the current selection. The Select button (step 106) causes some action to be taken according to the context of the highlighted item.

If the highlighted item is a Track Name, Select requests that that item be played (step 1061). Accordingly, any current activity of the player is cancelled and the new item requested. The display is updated for Song Display Mode.

If the item selected is a sub-menu (indicated by a right pointer at the far right end of the display line), then that sub-menu is selected and its display replaces the current one (step 1062). The previous menu display state is “pushed” onto a menu navigation stack so that it can be restored later. The new sub-menu is displayed with its Menu Name at the top of the display and the first item on the next line, highlighted in reverse-video.

In the Setup Menu and Wizard Menu, some items are not Track Names or sub-menus but control choices (step 1063). In these cases, the Select key causes the next available choice for the given item is selected and the line itself updated immediately to provide feedback. An example of this is toggling the Music Player's “Song Repeat Mode”.

Wizard

This key brings up the Wizard (step 107) with additional choices and selections according to the current state and context of the Remote and Player.

In one embodiment, the Wizard menu (step 1071) includes:

Change Player Repeat Mode

Change Player Shuffle Mode

Toggle Mute

Jukebox ON/OFF

Song Mode

Repeat and Shuffle modes are common features of Music Players. The present invention supports changing these modes and, by virtue of its having an LCD screen, shows their current state.

Jukebox is a feature of the two-way Remote and Cradle that allows the end user to select a series of songs for inclusion in the “Jukebox”. After this selection, the user may choose that the entire “Jukebox” set is played in the ordered selected.

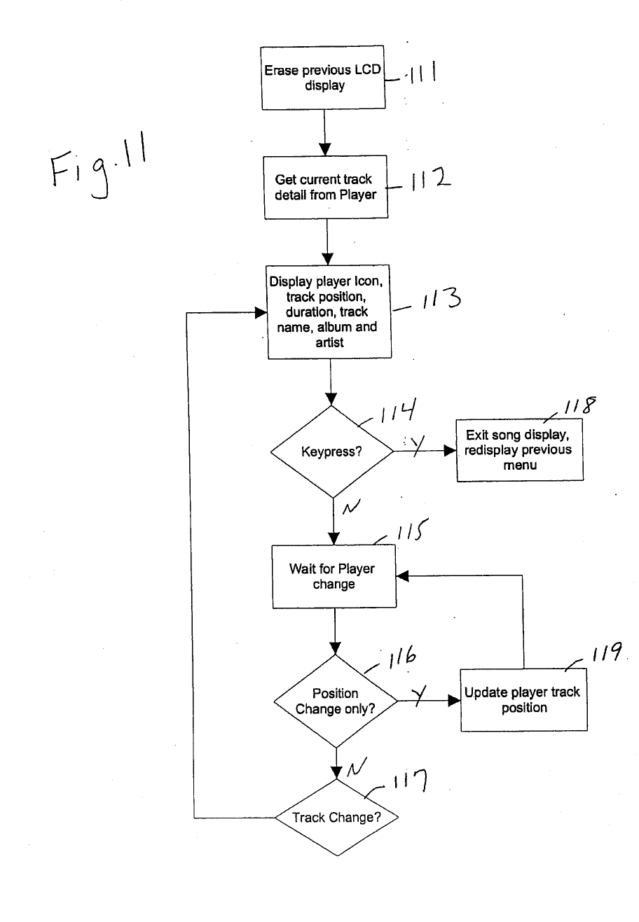

Song Play Mode Logic—Both Cradles and Host Adapter (FIG. 11)

With both Cradles and the Host Adapter, Song Play Mode is a display state on the Remote that shows the current state of the Music Player Device or Music Player Application. First, the LCD screen is cleared (step 111), and information regarding a current track is obtained from the Music Player (step 112).

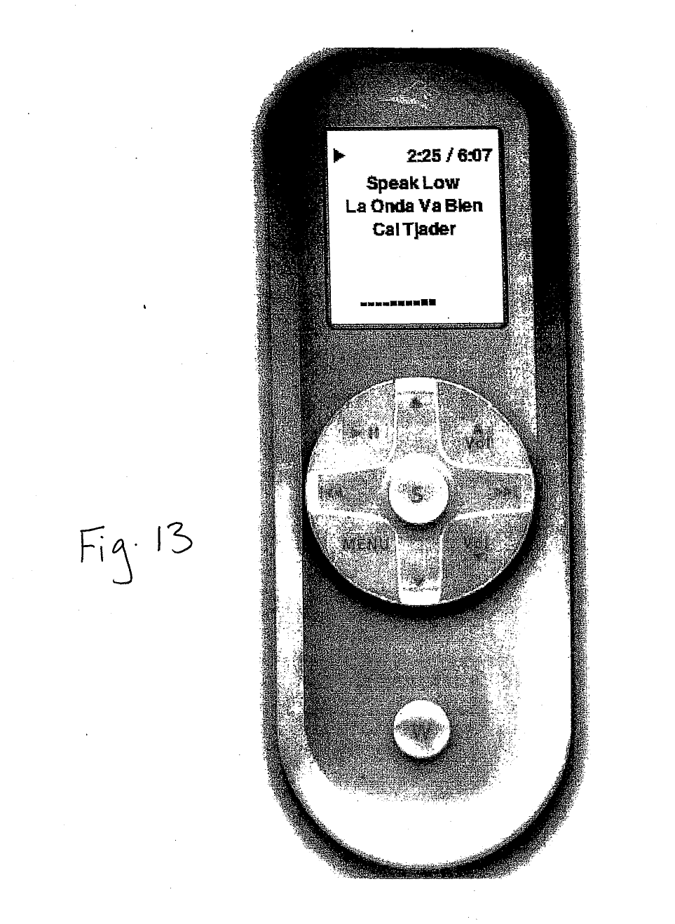

Song Display Mode shows the Track Name, Album Name and Artist Name of the current song or video that is playing. An example, of the Song Display is shown in FIG. 13. The Song Display Mode may also show the current position, to the second, within the selection as well as the total length of the selection (step 113). The same paradigm is used for audio books, “podcasts”, music videos and other selections. Because Music Players were first used to play music the terms “Track Name”, “Album Name” and “Artist Name” were commonly used and continue to be used and make up an important organizing principle for the Music Player Database, even though many non-music items have been added.

Accordingly, “Song Display Mode” uses no titles or headings and instead just shows the data items given these historical names. For any given selection, if any of the items (Track Name, Album Name or Artist Name) isn't available, it is just left out.

If none or only one of the data items (Track Name, Album Name or Artist Name) is available the name of the Playlist or other next available hierarchically higher organizing construct is used to supplement or whatever else is available.

The Song Display Mode is updated approximately once/second with the current “Track” position (steps 115, 116, 119). It is also updated if the Player reaches the end of one “Track” and starts on another (step 117).

Song Display Mode is terminated if a keypad button is pressed or when the Remote goes to sleep. If it is a keypad button (step 114), the key itself is ignored and the display is changed to the last displayed menu, exactly as it was (step 118). The user can then navigate as usual. If the player was playing, it is not interrupted by the user navigating unless a new Track is selected. While the player is playing and the user is navigating, the time since the last key press is tracked and once it reaches 5 seconds, the Remote switches back to Song Display Mode.

Song Display Mode is also entered immediately if the user selects a new Track or presses Play/Pause and the Player resumes playing.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a digital volume control, any other device an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to connectors, adapters, links, switches, microprocessors, regulators, enclosures, radios, amplifiers, antennas, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, downloading, transferring, and communicating track, album, and artist information between devices and a remote, managing display, retrieval and playing of entertainment tracks (including music, video and other data) on a standalone Cradle or via a Cradle Adapter, and the display, storage, or communication of results according to the processes of the present invention.

The present invention may suitably comprise, consist of, or consist essentially of, any of element (the various parts or features of the invention and their equivalents as described herein. Further, the present invention illustratively disclosed herein may be practiced in the absence of any element, whether or not specifically disclosed herein. Obviously, numerous modifications and variations of the present invention are possible in light of the above teachings. Therefore, it is to be understood that, within the scope of the appended claims, the invention may be practiced other than as specifically described herein.

What is claimed is:

1. A system for controlling a portable electronic audio or video media player, the system comprising:
a remote control unit; and
an interface adapter to connect the player to external audio or video output equipment;
wherein the remote control unit communicates with the interface adapter to control the player, and the interface unit communicates with the remote control unit to provide information from the player to the remote control unit.

2. The system of claim 1, wherein the remote control unit and the interface adapter communicate via a wireless RF link.

3. The system of claim 2, wherein the remote control includes control functions associated with the player, such that a user can control the operation of the player via the remote control unit.

4. The system of claim 3, wherein the remote control includes a display to display information of the contents stored in the player, such that a user can control the output of the player's contents.

5. The system of claim 4, wherein the interface adapter comprises a cache memory to store database information received from the player.

6. The system of claim 5, wherein the interface adapter comprises a menu handling state machine.

7. The system of claim 4, wherein the remote control unit comprises a cache memory to store data information received from the player via the interface adapter.

8. The system of claim 7, wherein the remote control unit comprises a menu handling state machine, such that at least some menu functions can be performed by the remote without communicating with the interface adapter.

9. The system of claim 1, wherein the interface adapter is configured to connect to an interface port of the player.

10. The system of claim 9, wherein the interface adapter further comprises an audio output connection to connect to external audio equipment.

11. The system of claim 10, wherein the interface adapter further comprises a video connection to connect to external video equipment.

12. The system of claim 11, wherein the interface adapter further comprises a USB connection to connect to a USB host system.

13. The system of claim 11, wherein the interface adapter further comprises a USB connection to connect to a USB power adapter.

14. The system of claim 1, wherein the interface adapter has a first connection to a player and a second connection to a player dock, wherein the player dock provides connections to external outputs.

15. The system of claim 14, wherein the remote control unit and host adapter communicate via an RF wireless link.

16. A remote control system for controlling the output of audio or video data from a personal computer, the system comprising:
a host adapter; and
a remote control unit;
wherein the remote control unit communicates wirelessly with the host adapter, the host adapter communicates wirelessly with the remote control unit to provide information from the personal computer, and wherein the remote control unit includes control functions to control the output of the audio or video data from the personal computer or from external audio or video output equipment connected to the personal computer.

17. A remote control unit to control a portable audio or video player, the remote control unit comprising:
a display;
a keypad;
a microprocessor; and
a digital two-way radio to communicate with an interface adapter, such that the remote control unit receives data relating the contents and format of the portable audio or video player, and displays the data on the display; and wherein the remote control unit sends control instructions to the interface adapter to control the operation of the portable audio or video player.

18. The remote control unit of claim 17, further comprising a cache memory to store data information received from the player via the interface adapter.

19. The remote control unit of claim 18, further comprising comprises a menu handling state machine, such that at least some menu functions can be performed by the remote without communicating with the interface adapter.

20. An interface adapter to provide remote wireless control to a portable audio or video player, the interface adapter comprising:
a player interface connection to electrically connect to the portable audio or video player;
at least one output port to connect the interface adapter to an external device; and
a digital radio, wherein the radio provide two-way communication with a wireless remote, such that the interface adapter receives control signal from the wireless remote and delivers the control signals to the portable audio or video player, and the interface adapter receives information from the portable audio or video player and sends the information to the wireless remote for display on the wireless remote.

21. The interface adapter of claim 20, further comprising a cache memory to store database information received from the player.

22. The interface adapter of claim 21, further comprising a menu handling state machine.

23. An interface adapter to provide remote wireless control to a portable audio or video player, the interface adapter comprising:
a player interface connection to electrically connect to the portable audio or video player;
a dock interface connection to electrically connect the interface adapter to a player docking station; and
a digital radio, wherein the radio provide two-way communication with a wireless remote, such that the interface adapter receives control signal from the wireless remote and delivers the control signals to the portable audio or video player, and the interface adapter receives information from the portable audio or video player and sends the information to the wireless remote for display on the wireless remote.

24. The interface adapter of claim 23, further comprising a cache memory to store database information received from the player.

25. The interface adapter of claim 24, further comprising a menu handling state machine.
